(19) United States
(12) Patent Application Publication
(10) Pub. No.: US 2022/0358900 A1
(43) Pub. Date: Nov. 10, 2022

(54) DRUM

(71) Applicant: Steinmetzmeister Permatinger GmbH, Munderfing (AT)

(72) Inventors: Anton Permatinger, Munderfing (AT); Patrick Permatinger, Munderfing (AT)

(21) Appl. No.: 17/623,229

(22) PCT Filed: Jul. 24, 2020
(86) PCT No.: PCT/AT2020/060275

§ 371 Date: Dec. 27, 2021

(30) Foreign Application Priority Data
Jul. 25, 2019 (AT) A50673/2019

(51) Int. Cl. G10D 13/22; G10D 13/16

(52) U.S. Cl. CPC G10D 13/22; G10D 13/16

(57) ABSTRACT

The invention relates to a drum having a drum shell which forms an upper and a lower part (1, 2), is divided by a system ring (3) and is covered on each of the two open cover sides by a respective drumhead (4) which is tensioned down on the drum by a respective tension hoop (5) which is fastened to the drum by way of tuning screws (6), wherein the tension hoops (5) are tensioned against the common system ring (3) by way of their respective tuning screws (6) with interposition of the upper and lower parts (1, 2) respectively. In order to create advantageous construction conditions, it is proposed that the drum shell consists at least in sections of stone material and that the upper and lower parts (1, 2) of the two-part drum shell are bonded to the system ring (3) via stone silicone as an adhesive.

### FIELD OF THE INVENTION

The invention relates to a drum having a drum shell which forms an upper and a lower part, is divided by a system ring and is covered on each of the two open cover sides thereof by a respective drumhead which is tensioned down on the drum by a respective tension hoop which is fastened to the drum by means of tuning screws, wherein the tension hoops are tensioned against the common system ring by means of their respective tuning screws with the upper and lower part being interposed.

### BRIEF DESCRIPTION OF THE PRIOR ART

Drums, such as a snare drum or a tom-tom, consist of a tubular drum shell whose open top is covered by a drumhead. The drumheads are stretched on the drum shell by means of tension hoops. Typically, the drum shells are made of wood.

It is known to manufacture the drum shells from different materials or components, especially for the formation of extraordinary sound characteristics. DE102015005713A1 shows a drum whose drum shell is made of two parts. The upper and lower parts of the drum shell can be connected to one another via two system rings which can be screwed into one another. By screwing the upper and lower parts into or out of each other, the height of the drum shell and thus the sound characteristics can be changed. As in DE20312710, which discloses a drum made of stone material, the tension hoops tensioning the drumheads are provided on the drum shell, as a result of which, particularly in the case of strongly tensioned drumheads, undesirable tension which has a negative influence on the sound characteristic is introduced into the drum shell.

US2001049993A1 discloses a drum with a drum shell forming an upper and a lower part and divided by a system ring. The open cover sides of the drum shell are covered by drumheads which are each tensioned down by tension hoops. The tension hoops are tensioned against the common system ring by their respective tuning screws, with the upper and lower parts being interposed. If the tension of the tension hoops is particularly high, however, tension can be transmitted from the system ring to the shell, resulting in an undesirable change in the sound characteristics.

US20120000341A1 discloses a drum having a drum shell formed by a plurality of drum segments. The drum shell may be made of plastic, wood, or metal. The drum segments forming the drum shell may be bonded together via an epoxy resin.

U.S. Pat. No. 5,377,576 also discloses a drum having a drum shell comprising a plurality of drum segments. The drum segments can be made of wood and metal.

US2018102116A1 discloses a drum having an upper and lower part forming a drum shell divided by a system ring. The upper and lower parts are made of wood and the system ring is made of stone and pressed together.

### SUMMARY OF THE INVENTION

The invention is thus based on the object of proposing a drum of the type described at the outset which, even when alternative drum shell materials which are sensitive to tension are used, permits particularly strong tensioning of the drumheads without negatively influencing the sound characteristics or damaging the drum shell material.

The invention solves the problem posed in that the drum shell consists, at least in sections, of stone material and in that the upper and lower parts of the two-part drum shell are bonded to the system ring via stone silicone as an adhesive. Unlike in the prior art, the tuning screws therefore do not engage directly with the drum shell, but with the system ring dividing the drum shell. In contrast to the drum shell, which is made of stone to produce special sound characteristics, the system ring is made of a highly stressable material, for example aircraft aluminum, which can absorb the forces induced by the tuning screws without damage. As a result, no inhomogeneous stresses are created in the drum shell, whereby undisturbed vibration propagation of the sound waves is achieved. Since it is known that a drum, such as a snare drum, has two tension hoops each surrounded by a drumhead, each of these tension hoops has its own set of tuning screws for independent tuning or tensioning of the drumheads. A particularly even and non-destructive tensioning of the drumheads is achieved when the tuning screws of the set of the tension hoop associated with the upper part are staggered with the tuning screws of the set of the tension hoop associated with the lower part and engage on the opposite sides of the common system ring. For this purpose, the system ring has receiving holes for these tuning screws. The tubular upper and lower parts of the drum shell can in principle be made of the same stone material, although embodiments in which different materials are used are also conceivable.

In order to adequately shield the forces induced by the tuning screws in the system ring from the drum shell, it is proposed that the upper and lower parts of the two-part drum shell are bonded to the system ring by means of an adhesive. Stone silicone, for example, is suitable for this purpose and ensures a secure fit of the upper and lower parts on the system ring. Surprisingly, it has been found that the elasticity of the stone silicone prevents an undesired transfer of tension from the system ring to the drum shell, but does not cause any negative effects with regard to the sound characteristics and sound propagation.

The use of the stone silicone in accordance with the invention prevents full-surface contact between the system ring and the upper and lower parts, so that undesirable tension transfer from the system ring to the drum shell is prevented. At the same time, the use of the stone silicone results in a special inherent sound, so that the stone silicone not only acts as a cohesive agent, but also positively influences the sound of the drum.

In order to keep the diffuse reflection of the sound from the shell of the drum as small as possible, it is recommended that the shell of the drum is surface smoothed on the inside. Manufacturing processes for surface smoothing, such as polishing or satin finishing, lead to a particularly clear sound experience.

In order to further increase the sound spectrum of the drum according to the invention, the upper part and/or lower part of the drum shell may be formed in several parts, wherein tubular drum shell sections of the upper part and/or lower part are glued to each other at the end face by an adhesive. The end face means the surface at which the drum shell sections contact each other when stacked on top of each other. In this case, the upper and/or lower part may thus comprise a plurality of drum shell sections which are likewise tubular in shape and which are bonded to one another by an adhesive means. There are no limits to the different design in terms of height, number and material of the individual drum shell sections. Also in this embodiment, the upper part consisting of a plurality of drum shell sections is divided from the lower part, possibly also consisting of a plurality of drum shell sections, by the system ring. A particularly secure bonding of the drum shell sections is achieved by the use of synthetic resin, in particular epoxy resin.

Unlike drums such as tom-toms, snare drums have a snare carpet resting on one of the drumheads, namely the resonator head, which resonates due to the vibration of the resonator head and produces the typical snare effect. However, this snare effect is not always desirable, which is why a tensioning device is usually provided on the drum to switch this effect on and off. Therefore, in order to be able to switch this snare effect on or off also in drums with sensitive drum shell materials, it is proposed that a tensioning device for tensioning a snare carpet arranged in the drum is provided on the tension hoop. As a result of this measure, the tensioning device is also decoupled from the drum shell and therefore has no negative influence on the desired sound characteristics.

### BRIEF DESCRIPTION OF THE INVENTION

In the drawing, the subject matter of the invention is shown by way of example, wherein:

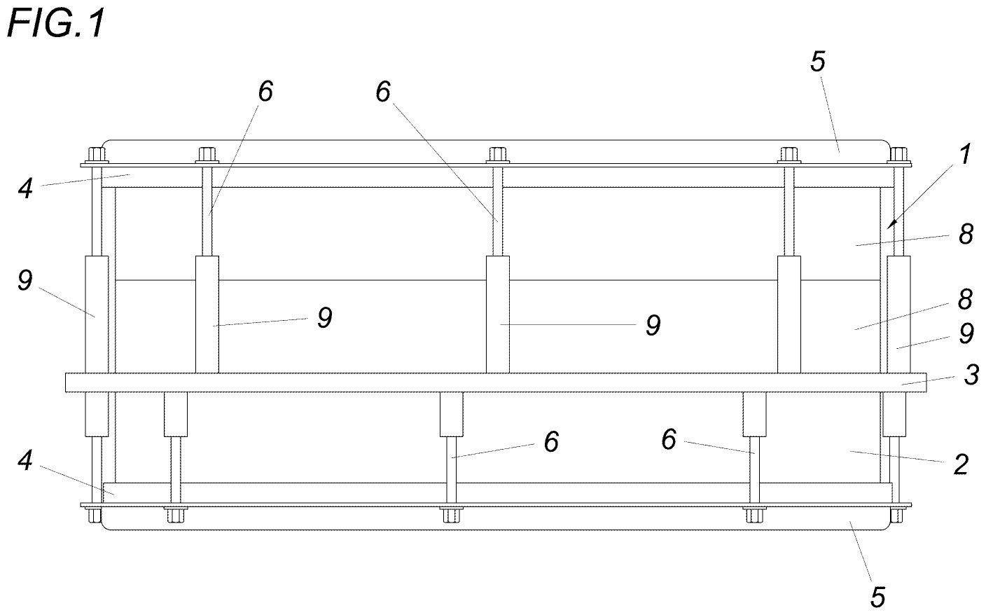

FIG. 1 shows a side view of the drum according to the invention and

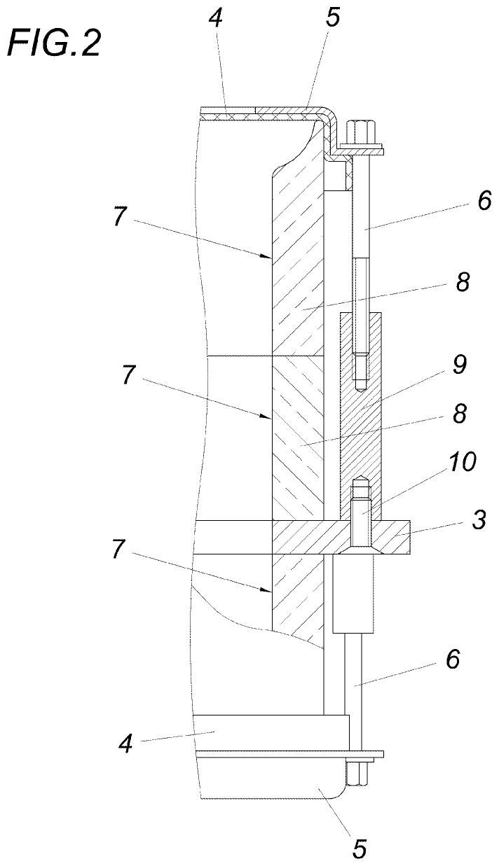

FIG. 2 shows a partially broken up detailed view of FIG. 1 on a larger scale.

### DETAILED DESCRIPTION OF THE PREFERRED EMBODIMENTS

A drum according to the invention has a drum shell formed by an upper part 1 and a lower part 2. The upper part 1 is separated from the lower part 2 by a system ring 3, as can be seen in particular from FIG. 1. The system ring 3 thus divides the drum shell, which is at least partly made of stone material. The tubular drum shell is covered on each of its two open sides by a drumhead 4, which is clamped to the drum by a tension hoop 5. The forces acting on the drumheads 4 from the tension hoops 5 can be adjusted by tuning screws 6. In contrast to the previously known prior art, however, these tuning screws 6 do not engage directly on the drum shell, but on the system ring 3, which divides the drum shell into an upper part 1 and a lower part 2, either directly or via connecting components known per se. As a result, the tension introduced by the tuning screws 6 is not introduced into the drum shell, which would lead to a distortion of the desired sound characteristics, but is derived from the system ring 3, which is made of, for example, aircraft aluminum. Each tension hoop 5 has its own set of tuning screws 6. A particularly non-destructive tensioning of the drumheads 4 is achieved when the tuning screws 6 of the set of the tension hoop 5 assigned to the upper part 1 are staggered with the tuning screws 6 of the set of the tension hoop 5 assigned to the lower part 2 and engage on the opposite sides of the common system ring 3.

For a secure fit of the upper part 1 and lower part 2 on the system ring 3, an adhesive is provided which is applied between upper part 1 and system ring 3 and lower part 2 and system ring 3. It has been found that stone silicone is particularly suitable as an adhesive with regard to an undisturbed sound quality of the drum.

A particularly clear sound experience is achieved if the inner surface 7 of the drum shell, i.e. the inside drum jacket of the drum shell, is smoothed. This can be done, for example, by polishing or satin finishing.

As shown in particular in FIG. 2, the upper part 1, but in an alternative embodiment also the lower part 2, may be formed in several parts. In this exemplary embodiment, the upper part 1 comprises two tubular or annular drum shell sections 8 which are bonded together by a synthetic resin.

FIG. 2 illustrates a possible design of the tuning screws 6, which can be attached to the system ring 3 via a threaded sleeve 9 and another screw 10.

1. A drum comprising:
a drum shell that forms an upper and a lower part, that is divided by a system ring and is covered on each of the two open cover sides by a respective drumhead each of which is tensioned down on the drum by a respective tension hoop that is fastened to the drum via tuning screws;
wherein the tension hoops are each tensioned against the system ring via the respective tuning screws thereof with the upper and lower parts interposed respectively; and
wherein the drum shell includes sections of stone material; and
wherein the upper and lower parts of the two-part drum shell are bonded to the system ring by stone silicone as an adhesive.

2. The drum according to claim 1, wherein the drum shell is surface-smoothed on an inside drum jacket of the drum shell.

3. The drum according to claim 1, wherein the upper part or the lower part of the drum shell is formed in tubular drum shell sections that are glued together at ends thereof by an adhesive.

4. The drum according to claim 3, wherein the adhesive is a synthetic resin.

5. The drum according to claim 1, wherein a tensioning device tensions a snare carpet disposed in the drum on the tension hoop.

6. The drum according to claim 2, wherein the upper part or the lower part of the drum shell is formed in tubular drum shell sections that are glued together at ends thereof by an adhesive.

7. The drum according to claim 6, wherein the adhesive is a synthetic resin.

8. The drum according to claim 2, wherein a tensioning device tensions a snare carpet disposed in the drum on the tension hoop.

9. The drum according to claim 3, wherein a tensioning device tensions a snare carpet disposed in the drum on the tension hoop.

10. The drum according to claim 4, wherein a tensioning device tensions a snare carpet disposed in the drum on the tension hoop.

11. The drum according to claim 5, wherein a tensioning device tensions a snare carpet disposed in the drum on the tension hoop.

12. The drum according to claim 6, wherein a tensioning device tensions a snare carpet disposed in the drum on the tension hoop.

13. The drum according to claim 7, wherein a tensioning device tensions a snare carpet disposed in the drum on the tension hoop.
